(19) United States
(12) Patent Application Publication
(10) Pub. No.: US 2005/0162590 A1
(43) Pub. Date: Jul. 28, 2005

(54) Liquid crystal device and projection display device

(75) Inventors: Kinya Ozawa, Suwa-shi (JP); Takaaki Tanaka, Matsumoto-shi (JP)

Correspondence Address: OLIFF & BERRIDGE, PLC, P.O. BOX 19928, ALEXANDRIA, VA, 22320, US

(73) Assignee: SEIKO EPSON CORPORATION, Tokyo (JP)

(21) Appl. No.: 11/029,461

(22) Filed: Jan. 6, 2005

(30) Foreign Application Priority Data
Jan. 23, 2004 (JP) 2004-015527
Sep. 9, 2004 (JP) 2004-261982

(51) Int. Cl. G02F 1/1333

(52) U.S. Cl. 349/110

(57) ABSTRACT

Exemplary embodiments of the invention provide a liquid crystal device including a metal light-shielding film having a structure capable of reducing or preventing light leakage caused by disclination generated at corners of a pixel region and of suppressing diffraction light caused by a knife edge. The liquid crystal device of exemplary embodiments of the present invention is provided with a first light-shielding film extending substantially in the direction parallel to a polarizing axis of incident light and in the direction perpendicular thereto. The clear viewing direction of liquid crystal obliquely intersects sides of a square-shaped pixel region, and at one of four corners of the pixel region that is located at the side opposite to the clear viewing direction, the edge of a pattern of the first light-shielding film is composed of a portion extending substantially in the direction parallel to the polarizing axis of the incident light and a portion extending substantially in the direction perpendicular thereto. At the other three corners, the edge of the pattern of the first light-shielding film obliquely intersects the polarizing axis of the incident light.

### BACKGROUND

Exemplary embodiments of the present invention relate to a liquid crystal device and a projection display device.

The related art includes liquid crystal devices that have been generally used as light modulating means (light valves) of projection display devices as well as direct-view-type display devices. In the liquid crystal device, there has been an increase in demand for enhancement of resolution. In particular, when the liquid crystal device is used as the light valve of the projection display device, high-resolution display devices have been strongly demanded since it is necessary to enlarge an image on the light valve. In addition, it is also demanded to secure a bright image and an aperture ratio of a pixel. As the liquid crystal light valve, an active matrix liquid crystal display of a twisted nematic (TN) mode in which thin film transistors (hereinafter, referred to as ‘TFTs’) are generally used as pixel switching elements, is adopted. In this way, it is possible to display an image with high contrast.

In particular, in the case of the projection display device, since strong light is incident on a liquid crystal panel from a light source, the light valve is provided with a metal light-shielding film for shielding the incident light to reduce or prevent the leakage of a current from TFTs in the liquid crystal light valve or a wrong operation thereof. In the active matrix liquid crystal light valve, this kind of metal light-shielding film is generally formed in a lattice shape to shield portions extending along the data lines and scanning lines in addition to the TFT portions, which is called a black matrix. Further, square-shaped opening portions of the lattice-shaped metal light-shielding film are actual pixel regions contributing to display.

When light having a predetermined polarizing axis is incident on the edge of a metal film, a certain type of diffraction phenomenon occurs, and the edge of the metal film appears to be bright, which is known as ‘a diffraction phenomenon caused by a knife edge’. See, for example, related art document 1: Applied Physical Optics Selection 1, ‘Applied Optics I’, (published by BAIFUKAN CO., LTD.), first edition, Jul. 20, 1990, pp. 199-205.

### SUMMARY

In the above-mentioned liquid crystal light valve, corners of the square-shaped opening portion in the metal light-shielding film is influenced by the electric filed from the TFT, the data line or the scanning line, or the horizontal electric field from adjacent pixels, resulting in the disorder (disclination) of liquid crystal. Then, light leakage occurs in a portion to be displayed black, which results in the lowering of a contrast ratio. Therefore, in order to shield places where disclination occurs, a pattern in which four corners of a square-shaped opening portion in a metal light-shielding film 101 are obliquely cut is used as shown in FIG. 8. This pattern makes it possible to reduce or prevent light leakage caused by disclination and thus to increase a contrast ratio. However, when a transmitting axis of a polarizing plate on the incident side (a polarizing axis of incident light) is set parallel to the data line or the scanning line by patterning the metal light-shielding film in this way, the corners of the opening portion in the metal light-shielding film appear to be bright due to the above-mentioned knife-edge diffraction phenomenon, which results in the remarkable lowering of a contrast ratio.

Accordingly, exemplary embodiments of the present invention are designed to address and/or solve the above-mentioned and/or other problems. Further, it is an object of exemplary embodiments of the present invention to provide a liquid crystal device including a metal light-shielding film having a structure capable of reducing or preventing light leakage caused by disclination generated at corners of a pixel region and of suppressing diffraction light caused by a knife-edge diffraction phenomenon. In addition, it is another object of exemplary embodiments of the present invention to provide a projection display device provided with the liquid crystal device, capable of displaying an image with high contrast.

In order to address or achieve the above objects, exemplary embodiments of the present invention provide a liquid crystal device in which liquid crystal is interposed between a pair of substrates, in which a metal light-shielding pattern extending substantially in the direction parallel to a polarizing axis of incident light and in the direction perpendicular thereto is provided on at least one of the pair of substrates, in which a clear viewing direction of the liquid crystal obliquely intersects sides of a substantially square-shaped pixel region partitioned by the metal light-shielding pattern, in which an edge of the metal light-shielding pattern at one or more of four corners of the pixel region has a portion obliquely intersecting the polarizing axis of the incident light, and in which the edge of the metal light-shielding pattern at a corner located at the side opposite to the clear viewing direction is composed of a portion extending substantially in the direction parallel to the polarizing axis of the incident light and a portion extending substantially in the direction perpendicular thereto.

The clear viewing direction of liquid crystal is a direction corresponding to the direction in which liquid crystal molecules are vertically aligned when a voltage is applied (or in a case in which liquid crystal molecules are vertically aligned in an initial state, the direction in which they are inclined), or is determined as the direction in which an interface is rubbed.

As described in related art document 1, when the edge of a metal light-shielding pattern 101 at corners of a square-shaped pixel region 102 obliquely intersects a polarizing axis of incident light as shown in FIG. 8, only the edge portion (portions in circles A, B, C, and D surrounded by dotted lines) the metal light-shielding pattern obliquely intersected appears to be bright. The present inventors actually confirm the fact that, when polarized light is incident on a substrate in which the edges of the metal light-shielding pattern at four corners of each pixel region is obliquely formed, those portions appear to be bright, which coincides with theory. As a result of confirming the substrate, all the four corners appear to be bright. However, when the same experiment is performed on a liquid crystal cell in which liquid crystal is interposed between the substrate and another substrate, it is confirmed that only one corner appears to be bright. In addition, the inventors confirm the fact that the position of the corner appearing brightly is relevant to the clear viewing direction of liquid crystal. Therefore, an object of exemplary embodiments of the present invention is addressed or achieved based on this knowledge of the inventors.

That is, the present inventors confirmed that, when the clear viewing direction of liquid crystal (the arrow direction in FIG. 8) was set to obliquely intersect sides of a square, which is an outline of the pixel region 102, only the edge of the metal light-shielding pattern at a corner located at the side opposite to the clear viewing direction (that is, when the ‘clear viewing direction’ is defined as the arrow direction, ‘the side opposite to the clear viewing direction’ is a direction opposite to the arrow direction) appeared brightly. Therefore, when the edge of the metal light-shielding pattern 101 at the corner C is formed so as not to incline with respect to the polarizing axis of the incident light, that is, is formed at a right angle composed of a portion extending substantially in the direction parallel to the polarizing axis of the incident light and a portion extending substantially in the direction perpendicular thereto, it is possible for the edge of the metal light-shielding pattern not to brightly appear. That is, for three corners A, B, and C that does not appear to be bright, the edge of the metal light-shielding pattern can be arranged to incline with respect to the polarizing axis of the incident light, and the vicinities of corners of an opening portion in the metal light-shielding pattern can be covered. As a result, it is possible to reduce or prevent light leakage caused by disclination generated at corners of the pixel region. Therefore, according to the liquid crystal device of exemplary embodiments of the present invention, it is possible to reduce or prevent light leakage caused be disclination and to suppress diffraction light caused by a knife-edge diffraction phenomenon, thereby enhancing a contrast ratio as a whole.

Further, it is preferable that the pair of substrates be an element substrate having pixel switching elements composed of TFTs thereon and a counter substrate, and that the metal light-shielding pattern be provided closer to a light incident side than the pixel switching element in the element substrate.

According to the above-mentioned structure, in an active matrix liquid crystal device having the element substrate and the counter substrate, it is possible to reduce or prevent light from being incident on the pixel switching element using the metal light-shielding pattern. Therefore, it is possible to realize a liquid crystal device capable of reducing a light leakage current of the TFT and of being operated well with lower power.

In this case, it is preferable that a light-shielding pattern be provided on the counter substrate, and that the light-shielding pattern covers the vicinity of a corner of an opening portion in the metal light-shielding pattern, the corner being located at the side opposite to the clear viewing direction.

That is, according to the structure of exemplary embodiments of the present invention, it is possible to suppress diffraction light caused by the knife-edge diffraction phenomenon by the shape of the metal light-shielding pattern provided on the element substrate. On the other side, it is difficult to reduce or prevent light leakage caused by disclination. Therefore, for example, when the light-shielding pattern is provided on the counter electrode so as to cover the vicinity of the corner located at the side opposite to the clear viewing direction in the opening portion of the metal light-shielding pattern, it is possible to reduce or prevent light leakage caused by disclination. However, in this case, it is necessary that the light-shielding pattern provided on the counter electrode be arranged so as not to incline with respect to the polarizing axis of the incident light.

Further, in the metal light-shielding pattern a portion extending substantially in the direction parallel to the polarizing axis of the incident light and a portion extending substantially in the direction perpendicular thereto are integrally formed in the same layer. Alternatively, a pattern extending substantially in the direction parallel to the polarizing axis of the incident light and a pattern extending substantially in the direction perpendicular thereto may formed in a lattice shaped in plan view, and these patterns may be formed on different layers.

According to the above-mentioned structure, the portion extending substantially in the direction parallel to the polarizing axis of the incident light and the portion extending substantially in the direction perpendicular thereto are integrally formed in the same layer. In this case, the present inventors confirmed that, even when the corner located at the side opposite to the clear viewing direction is designed to have a right angle in a photo mask (design), a roundish corner is formed due to the characteristics of a photolithography process and an etching process of manufacturing processes in actual manufacturing, and that this portion appears to be bright due to a diffraction phenomenon. However, according to the present exemplary embodiment, in the metal light-shielding pattern, when the pattern extending substantially in the direction parallel to the polarizing axis of the incident light and the pattern extending substantially in the direction perpendicular thereto are separately formed, and when these patterns are formed on different layers, it is possible to more reliably suppress diffraction light caused by a knife edge without rounding a corner of the pattern.

Furthermore, a projection display device of exemplary embodiments of the present invention includes a light source; a light modulating device to modulate light from the light source; and a projecting device to project the light modulated by the modulating device, in which the liquid crystal device according to exemplary embodiments of the present invention is used as the light modulating device.

According to exemplary embodiments of the present invention, since the liquid crystal device of exemplary embodiments of the present invention are used as the light modulating device, it is possible to realize a projection display device capable of displaying an image with a high contrast ratio.

### BRIEF DESCRIPTION OF THE DRAWINGS

FIG. 1 is a schematic equivalent circuit diagram of a liquid crystal device according to a first exemplary embodiment of the present invention;

FIG. 2 is a schematic plan view illustrating each pixel of the liquid crystal device:

FIG. 3 is a schematic plan view illustrating only a pattern of a light-shielding film of the liquid crystal device;

FIG. 4 is a schematic cross-sectional view of the liquid crystal device;

FIG. 5 is a schematic plan view illustrating a pattern of a light-shielding film of a liquid crystal device according to a second exemplary embodiment of the present invention;

FIG. 6 is a schematic cross-sectional view taken along the line B-B′ of FIG. 5;

FIG. 7 is a view schematically illustrating the structure of a projection display device of exemplary embodiments of the present invention; and

FIG. 8 is a schematic view illustrating a diffraction phenomenon caused by a knife edge.

### DETAILED DESCRIPTION OF PREFERRED EMBODIMENTS

### First Exemplary Embodiment

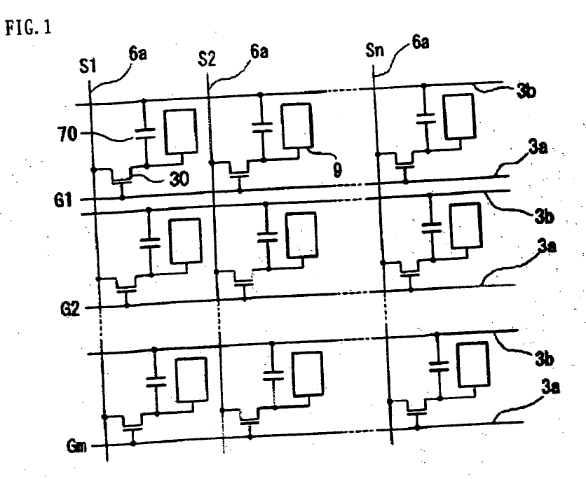

Hereinafter, a first exemplary embodiment of the present invention will be described with reference to FIGS. 1 to 4.

A liquid crystal device according to the present exemplary embodiment is an active matrix transmissive liquid crystal device using TFTs as switching elements.

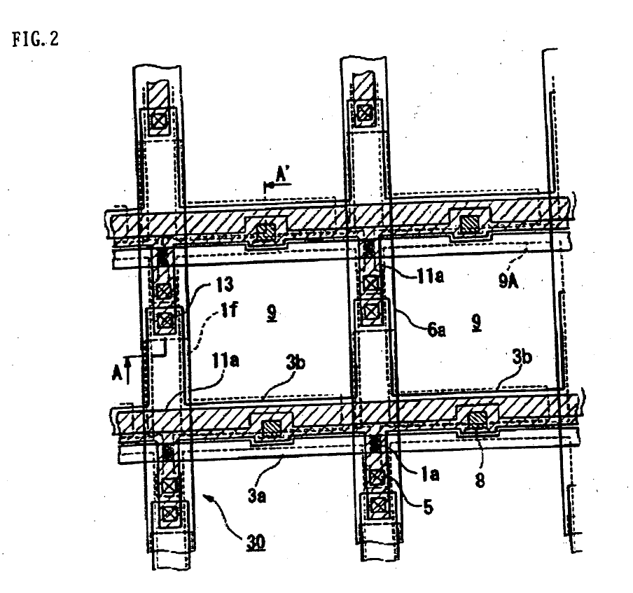

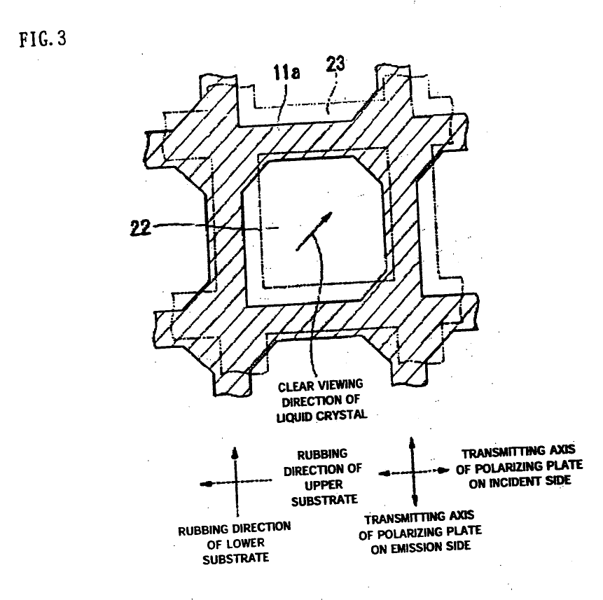

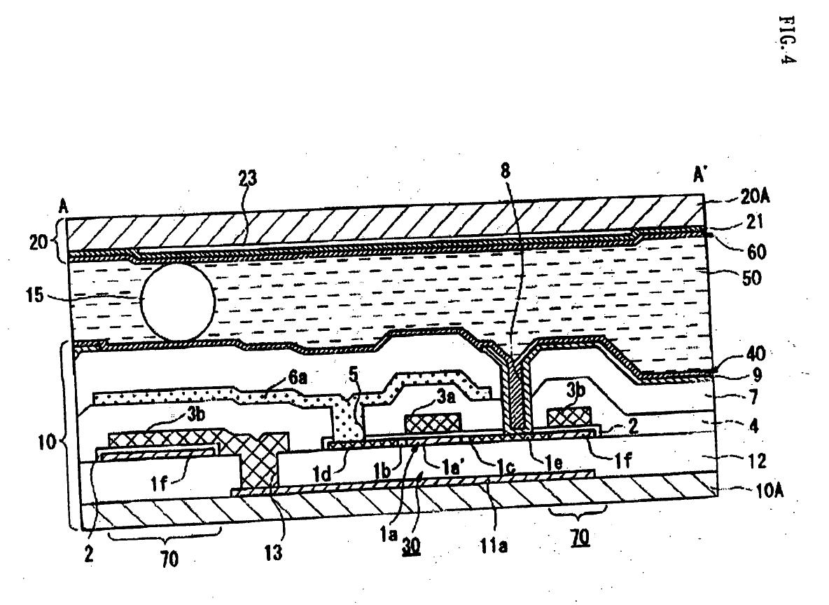

FIG. 1 is an equivalent circuit diagram of switching elements and signal lines of a plurality of pixels arranged in a matrix in the transmissive liquid crystal device according to the present exemplary embodiment. FIG. 2 is a schematic plan view illustrating the structure of a plurality of pixel groups adjacent to each other on a TFT array substrate on which data lines, scanning lines, and pixel electrodes are formed. FIG. 3 is a schematic view illustrating only a light-shielding film in the plan view of FIG. 2. FIG. 4 is a schematic cross-sectional view taken along the line A-A′ of FIG. 2. In addition, in FIG. 4, an upper side is a light incident side, and a lower side is a viewing side (an observer side). Further, in the following figures, since each layer or each member is shown in a size to be easily recognizable, each layer or each member has different reduced scales in the respective figures.

In the transmissive liquid crystal device according to the present exemplary embodiment, as shown in FIG. 1, the plurality of pixels arranged in a matrix each have a pixel electrode 9 and a TFT 30 serving as a switching element to control current passage to the pixel electrode 9. In each pixel, a source of the TFT 30 is connected to a data line 6a through which an image signal is supplied. The image signals S1, S2, . . . , Sn to be written on the data line 6a are sequentially supplied to the data lines in this order, or are supplied to each group consisting of a plurality of the data lines 6a adjacent to each other.

Further, a scanning line 3a is electrically connected to a gate of the TFT 30, and scanning signals G1, G2, . . . , Gm are sequentially applied to a plurality of the scanning lines 3a in a periodic pulse-wise manner at a predetermined timing in this order. In addition, the pixel electrode 9 is electrically connected to a drain of the TFT 30 and maintains the TFT 30, serving as a switching element, to be an ON state for a predetermined period of time, so that the image signals S1, S2, . . . , Sn supplied from the data lines 6a are written at a predetermined timing. The image signals S1, S2, . . . , Sn having a predetermined level that are written on liquid crystal through the pixel electrodes 9 are held for a predetermined period of time between the pixel electrodes and a common electrode to be described later. The liquid crystal modulates light by changing its molecular arrangement or order by a voltage level applied, which enables grayscale display. In order to reduce or prevent the held image signal from leaking, a storage capacitor 70 is additionally provided in parallel to liquid crystal capacitance formed between the pixel electrode 9 and the common electrode.

Next, the plane structure of the main parts of a transmissive liquid crystal device according to the present exemplary embodiment will be described with reference to FIG. 2.

As shown in FIG. 2, a plurality of square-shaped pixel electrodes 9 (whose outline is represented by a dotted line 9A) made of a transparent material, such as indium tin oxide (hereinafter, referred to as ITO), are provided in a matrix on a TFT array substrate, and the data lines 6a, the scanning lines 3a, and capacitive lines 3b are lengthwise and widthwise provided along the boundaries between the pixel electrodes 9. In the present exemplary embodiment, a region in which each pixel electrode 9, and the data line 6a, the scanning line 3a, and the capacitive line 3b arranged to surround each pixel electrode 9 are formed is a pixel, and it is possible to perform display for each of the pixels arranged in a matrix.

The data line 6a is electrically connected to a source region, which will be described later, of a semiconductor layer 1a composed of, for example, a polysilicon film constituting the TFT 30 through a contact hole 5, and the pixel electrode 9 is electrically connected to a drain region, which will be described later, of the semiconductor layer 1a through a contact hole 8. In addition, the scanning line 3a is arranged so as to face a channel region (a hatched region in which parallel hatch lines are inclined toward its upper left corner in FIG. 2), which will be described later, of the semiconductor layer 1a, and a portion of the scanning line 3a facing the channel region functions as a gate electrode. The capacitive line 3b has a main line extending along the scanning line 3a substantially in a straight-line shape (that is, a first region formed along the scanning line 3a in plan view) and a projecting portion protruding from a place intersecting the data line 6a toward the front stage (the upper direction of FIG. 2) along the data line 6a (that is, a second region extending along the data line 6a in plan view in FIG. 2).

Further, a lattice-shaped first light-shielding film 11a (a metal light-shielding pattern) made of a metallic material, such as chrome, is provided in a region (a hatched region in which parallel hatch lines are inclined toward its upper right corner in FIG. 2) extending along the data line 6a and the scanning line 3a. FIG. 3 is a schematic plan view illustrating only the light-shielding film in order for easily viewing of FIG. 2. In the present exemplary embodiment, a TN mode in which liquid crystal molecules are twisted by 90° is used as a liquid crystal mode. As shown in FIG. 3, a rubbing process is performed on a counter substrate, which is an upper substrate, in the direction from the right to the left of FIG. 3 along the scanning lines 3a. On the other side, the rubbing process is performed on the TFT array substrate, which is a lower substrate, in the direction from the lower side to the upper side of FIG. 3 along the data lines 6a. In this case, the clear viewing direction of liquid crystal is a direction obliquely intersecting the sides of a square, which is the outline of a pixel region 22, that is, a direction from the lower left corner toward the upper right corner of FIG. 3. Further, the direction of a transmitting axis of a polarizing plate (polarizer) on the incident side is set along the scanning line 3a, and the direction of a transmitting axis of a polarizing plate (polarizer) on the emission side is set along the data line 6a. Therefore, a cross-Nicol arrangement is adopted.

In the first light-shielding film 11a, at one (a lower right corner in FIG. 3) of four corners of the square-shaped pixel region 22 that is located at the side opposite to the clear viewing direction of liquid crystal, the edge of the pattern of the first light-shielding film 11a is formed at a right angle formed by a side extending in the direction parallel to a polarizing axis (the transmitting axis of the polarizing plate on the incident side) of incident light and a side extending in the direction orthogonal thereto. Meanwhile, the edge of the pattern of the light-shielding film 11a at the other three corners (an upper right corner, an upper left corner, and a lower left corner in FIG. 3) is formed of sides obliquely extending with respect to the direction of the polarizing axis of incident light. Furthermore, FIG. 3 shows a pattern of a second light-shielding film 23 provided on the counter substrate in addition to the pattern of the first light-shielding film 11a provided on the TFT array substrate. The pattern of the second light-shielding film 23 is formed in a lattice shape, similar to the first light-shielding film 11a. However, four corners are not inclined with respect to the direction of the polarizing axis of incident light. In the corner located at the opposite side of the clear viewing direction of liquid crystal, a portion of the pixel region 22 not covered with the first light-shielding film 11a is covered with the second light-shielding film 23.

Next, the sectional structure of the transmissive liquid crystal device according to the present exemplary embodiment will be described with reference to FIG. 4. As described above, FIG. 4 is a schematic cross-sectional view taken along the line A-A′ of FIG. 2 and shows the structure of a region in which the TFT 30 is formed. In the transmissive liquid crystal device according to exemplary embodiments of the present invention, a liquid crystal layer 50 is interposed between a TFT array substrate 10 and a counter substrate 20 arranged opposite thereto.

The TFT array substrate 10 mainly includes a substrate base 10A made of a transmissive material, such as quartz, the TFTs 30 formed on a surface of the substrate base 10A facing the liquid crystal layer 50, the pixel electrodes 9, and an alignment film 40. The counter substrate 20 mainly includes a substrate base 20A made of a transmissive material, such as glass or quartz, a common electrode 21 formed on a surface of the substrate base 20A facing the liquid crystal layer 50, and an alignment film 60. In addition, spacers 15 are provided between the substrates 10 and 20 to maintain a predetermined gap therebetween.

In the TFT array substrate 10, the pixel electrodes 9 are provided on the surface of the substrate base 10A facing the liquid crystal layer 50, and the pixel switching TFTs 30 to control the switching of each pixel electrode 9 are provided at positions adjacent to each pixel electrode 9. The pixel switching TFT 30 has an LDD (Lightly Doped Drain) structure and includes the scanning line 3a, a channel region 1a′ of the semiconductor layer 1a in which a channel is formed by the electric field from the scanning line 3a, a gate insulating film 2 to insulate the scanning line 3a from the semiconductor layer 1a, the data line 6a, a lightly doped source region 1b and a lightly doped drain region 1c of the semiconductor layer 1a, and a heavily doped source region 1d and a heavily doped drain region 1e of the semiconductor layer 1a.

A second interlayer insulating film 4 is formed on the scanning lines 3a and the gate insulting film 2 on the substrate base 10A, and the contact hole 5 passing through the heavily doped source region 1d and a contact hole 8 passing through the heavily doped drain region 1e are formed in the second interlayer insulating film 4. The data line 6a is electrically connected to the heavily doped source region 1d through the contact hole 5 passing through the second interlayer insulating film 4. In addition, a third interlayer insulating film 7 is formed on the data line 6a and the second interlayer insulating film 4, and the contact hole 8 reaching the heavily dope drain region 1e also passes through the third interlayer insulating film 7. That is, the heavily doped drain region 1e is electrically connected to the pixel electrode 9 through the contact hole 8 passing through the second interlayer insulting film 4 and the third interlayer insulating film 7. In the present exemplary embodiment, the gate insulating film 2 extends to a position opposite to the scanning line 3a and is used as a dielectric film, and the semiconductor film 1a extends as a first storage capacitor electrode 1f. In addition, a portion of the capacitive line 3b opposite to the first storage capacitor electrode If is used as a second storage capacitor electrode, and the first and second storage capacitor electrodes constitute a storage capacitor 70.

In the surface of the substrate base 10A of the TFT array substrate 10 facing the liquid crystal layer 50, the first light-shielding film 11a is provided in a region in which each pixel switching TFT 30 is formed. The first light-shielding film 11a functions to reduce or prevent light that passes through the TFT array substrate 10 and is then reflected from a lower surface (the boundary between the TFT array substrate 10 and air) of the TFT array substrate 10 to return to the liquid crystal layer 50 from being incident on at least the channel region 1a′, the lightly doped source region 1b, and the lightly doped drain region 1c of the semiconductor layer 1a. As described above, the present exemplary embodiment is characterized by the plane shape of the first light-shielding film 11a.

A first interlayer insulating film 12 is formed between the first light-shielding film 11a and the pixel switching TFT 30 to insulate the first light-shielding film 11a from the semiconductor layer 1a constituting the pixel switching TFT 30. Further, as shown in FIG. 2, in addition to providing the first light-shielding film 11a on the TFT array substrate 10, the first light-shielding film 11a is electrically connected to the capacitive line 3b located at the front stage or the latter stage thereof through a contact hole 13.

Further, an alignment film 40 to control the alignment of liquid crystal molecules in the liquid crystal layer 50 at the time when a non-selected voltage is applied, is formed on the outermost surface of the TFT array substrate 10 facing the liquid crystal layer 50, that is, on the pixel electrode 9 and the third interlayer insulating film 7.

On the other side, in the surface of the substrate base 20A of the counter substrate 20 facing the liquid crystal layer 50, the second light-shielding film 23 is provided in a region opposite to the region in which the data line 6a, the scanning line 3a, and the pixel switching TFT 30 are formed, that is, in regions other than an opening region of each pixel unit. The second light-shielding film 23 functions to reduce or prevent incident light from being transmitted through the channel region 1a′, the lightly doped source region 1b, and the lightly doped drain region 1c of the semiconductor layer 1a of the pixel switching TFT 30. In addition, the common electrode 21 made of, for example, ITO is formed to cover almost the entire surface of the substrate base 20A facing the liquid crystal layer 50 on which the second light-shielding film 23 is formed. An alignment film 60 to control the alignment of liquid crystal molecules in the liquid crystal layer 50 at the time when a non-selected voltage is applied, is formed on the surface of the common electrode 21 facing the liquid crystal layer 50.

In the liquid crystal device of the present exemplary embodiment, at one of four corners of the square-shaped pixel region 22 that is located at the side opposite to the clear viewing direction of liquid crystal, the edge of the pattern of the first light-shielding film 11a is designed so as not to incline with respect to the polarizing axis of incident light. Therefore, it is possible for the edge of the pattern not to appear to be bright due to a diffraction phenomenon caused by a knife edge. In addition, the edge of the pattern of the first light-shielding film 11a at the remaining three corners can be designed so as to incline with respect to the polarizing axis of the incident light. Therefore, it is possible to cover the vicinities of corners of an opening portion in the pattern of the first light-shielding film 11a. As a result, it is possible to reduce or prevent the leakage of light caused by disclination generated at corners of the pixel region 22. As such, according to the liquid crystal device of the present exemplary embodiment, it is possible to reduce or prevent the leakage of light caused by disclination and to suppress diffraction light caused by a knife-edge diffraction phenomenon. Therefore, it is possible to enhance a contrast ratio as a whole.

Further, according to the above-mentioned structure, it is possible to suppress diffraction light caused by the knife-edge diffraction phenomenon by using the pattern shape of the first light-shielding film 11a. However, it is difficult to reduce or prevent the leakage of light caused by the disclination in the vicinities of corners. In order to address or solve the above-mentioned and/or other problems, in the present exemplary embodiment, the pattern of the second light-shielding film 23 on the counter substrate 20 is formed so as to cover the vicinity of a corner located at the side opposite to the clear viewing direction in the opening portion of the first light-shielding film 11a. Therefore, it is possible to reduce or prevent the leakage of light caused by disclination at that portion. In addition, even when a diffraction phenomenon occurs due to a roundish corner generated when the device is actually manufactured, it is possible to shield the diffraction light using the second light-shielding film 23. Of course, in the pattern of the second light-shielding film 23, the edge of a corner located at the side opposite to the clear viewing direction of liquid crystal is also not inclined with respect to the polarizing axis of incident light. Therefore, a diffraction phenomenon caused by a knife edge does not occur.

### Second Exemplary Embodiment

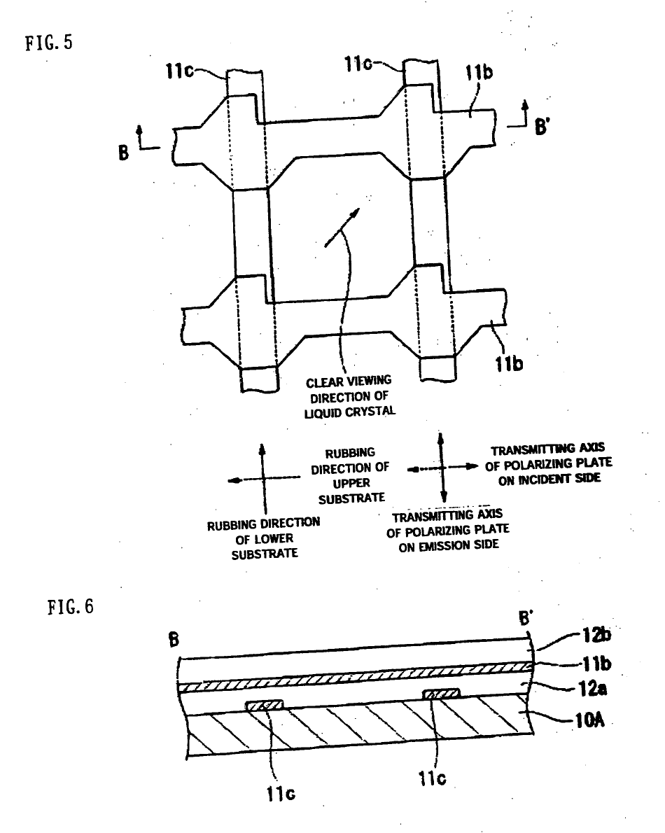

Next, a second exemplary embodiment of the present invention will be described with reference to FIGS. 5 and 6.

The basic structure of a liquid crystal device according to the present exemplary embodiment is the same as that in the first exemplary embodiment except the structure of a light-shielding film.

FIG. 5 is a schematic plan view illustrating only a first light-shielding film of a liquid crystal device according to the present exemplary embodiment, and FIG. 6 is a schematic cross-sectional view taken along the line B-B′ of FIG. 5. In FIG. 6, only a portion from the substrate base of the TFT array substrate to the first interlayer insulating film 12 is shown, but portions above the TFT 30 are not shown. Therefore, only the structure of a light-shielding film will be described with reference to FIGS. 5 and 6.

In the first exemplary embodiment, the first light-shielding film 11a provided on the TFT array substrate 10 is integrally formed in a lattice shape in the same layer as a metal film. However, in the present exemplary embodiment, as shown in FIG. 5, in the first light-shielding film 11a, a portion 11b (a portion extending widthwise in FIG. 5) extending along the scanning line 3a and a portion 11c (a portion extending lengthwise in FIG. 5) extending along the data line 6a are separate patterns and are formed of a two-layered structure. As shown in FIG. 6, in a sectional structure thereof, the portion 1c extending along the data line 6a is formed on the upper surface of the substrate base 10A, and a first lower interlayer insulating film 12a is formed thereon. In addition, the portion 11b extending along the scanning line 3a is formed on the first lower interlayer insulating film 12a, and a first upper interlayer insulating film 12b is formed thereon. Further, the portion 11b extending along the scanning line 3a and the portion 11c extending along the data line 6a may be reversed to each other in position. In addition, at three corners of the pixel region 22, in order to obliquely cover an opening portion, a wide width portion of the first light-shielding film is formed at the side of the portion 11b extending along the scanning line 3a, or may be formed at the side of the portion 11c extending along the data line 6a.

In the first exemplary embodiment, the portion extending along the scanning line 3a and the portion extending along the data line 6a are integrally formed in the same layer. However, in this case, even when the corner located at the side opposite to the clear viewing direction is designed to have a right angle in a photo mask (design), a roundish corner is formed due to the characteristics of a photolithography process and an etching process of manufacturing processes in actual manufacturing, and this portion appears to be bright due to a diffraction phenomenon. However, according to the present exemplary embodiment, the portion 11b extending along the scanning line 3a and the portion 1c extending along the data line 6a are formed by separate patterns, and these patterns are formed in different layers. Then, a right-angled corner is formed by intersecting both straight-line portions. Therefore, it is possible to more reliably reduce or prevent diffraction light caused by a knife edge without rounding a corner of the pattern. In addition, in the present exemplary embodiment, although the structure of the second light-shielding film 23 on the counter substrate 20 is not mentioned, the corners of the second light-shielding film 23 may be covered in order to reduce or prevent the leakage of light caused by disclination in the vicinities of the corners in addition to reducing or preventing the diffraction light caused by the knife edge.

### Third Exemplary Embodiment

Hereinafter, a third exemplary embodiment of the present invention will be described.

The basic structure of a liquid crystal device according to the present exemplary embodiment is the same as that in the first exemplary embodiment except the alignment of liquid crystal molecules.

In the first exemplary embodiment, the liquid crystal molecules are horizontally aligned in an initial state, and a liquid crystal mode in which the liquid crystal molecules are twisted by 90° is used. However, according to the third exemplary embodiment, the liquid crystal molecules are aligned substantially in the vertical direction in an initial state, and a liquid crystal mode in which the liquid crystal molecules are not twisted is used. The term ‘substantially in the vertical direction’ means that vertical axes of liquid crystal molecules are inclined by about 5°, which is a predetermined pre-tilt angle for determining the inclining direction of liquid crystal molecules at the time when a voltage is applied. A vertical alignment film is obtained by depositing a SiO₂ material at a certain angle using a vapor deposition apparatus. A pre-tilt angle and the clear viewing direction are determined by the angle and direction of deposition. An arrow shown in FIG. 3 indicates the inclining direction of liquid crystal molecules.

When an alignment mode in which liquid crystal molecules are vertically aligned in an initial state is used, the phase difference of the liquid crystal layer is almost zero at the time when a non-selected voltage is applied, and a polarizing plate is aligned in a cross-Nicol arrangement. However, the leakage of light from the corners occurs under the influence of a knife edge.

In the liquid crystal device according to the present exemplary embodiment, at one of four corners of the square-shaped pixel region 22 that is located at the side opposite to the clear viewing direction of liquid crystal, the edge of the pattern of the first light-shielding film 11a is designed so as not to incline with respect to the polarizing axis of incident light. Therefore, it is possible for the edge of the pattern not to appear to be bright due to a diffraction phenomenon caused by a knife edge. In addition, the edge of the pattern of the first light-shielding film 11a at the other three corners can be designed so as to incline with respect to the polarizing axis of the incident light. Therefore, it is possible to cover the vicinities of corners of an opening portion in the pattern of the first light-shielding film 11a. As a result, it is possible to more greatly enhance a contrast ratio as a whole by vertically aligning liquid crystal molecules and by suppressing the knife edge, compared to the first exemplary embodiment.

Projection Display Device

Next, an exemplary embodiment of a projection display device (a liquid crystal projector) equipped with the transmissive liquid crystal device described in the above-mentioned exemplary embodiments will be described.

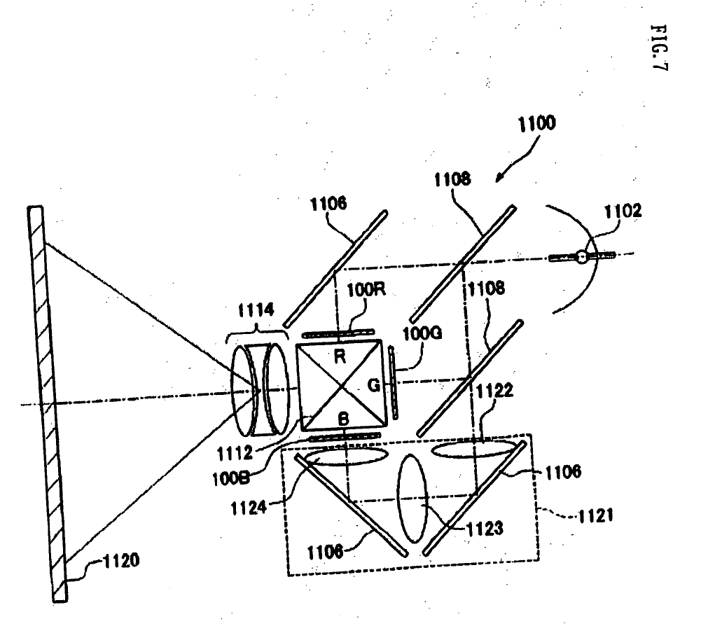

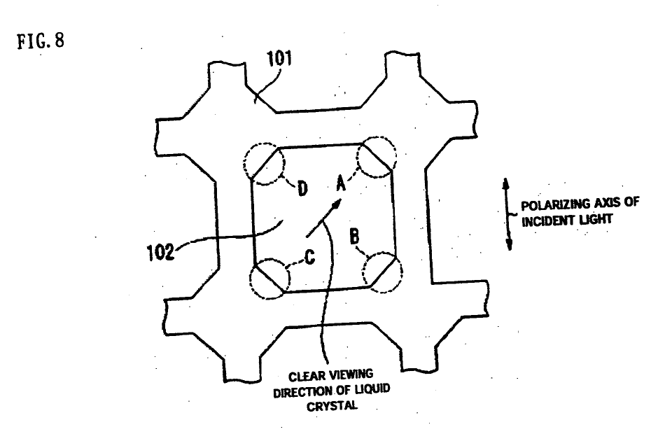

FIG. 7 is a view schematically illustrating the structure of the liquid crystal projector. As shown in FIG. 7, a projector 1100 is provided with a lamp unit 1102 composed of a white light source, such as a halogen lamp. Projection light emitted from the lamp unit 1102 is divided into the three primary colors of red (R), green (G), and blue (B) by three mirrors 1106 and two dichroic mirrors 1108 provided therein, and the light components corresponding to the three primary colors are guided to light valves 100R, 100G, and 100B, respectively.

The structure of the light valves 100R, 100G, and 100B is similar to that of the liquid crystal device according to the above-mentioned exemplary embodiment, and the light valves 100R, 100G, and 100B are driven by R, G, and B color signals supplied from a processing circuit (not shown) for inputting an image signal, respectively. In addition, since a light component B has an optical path longer than those of the other light components R and G, the light component B is guided to the light valve 100B through a relay lens system 1121 including an incident lens 1122, a relay lens 1123, and an emission lens 1124 in order to reduce or prevent the loss of light.

The light components modulated by the respective light valves 100R, 100G, and 100B are incident on a dichroic prism 1112 in three directions. Then, in the dichroic prism 1112, the light components R and B are refracted by 90°, while the light component G travels straight. In this way, after images of the respective colors are synthesized, a color image is projected onto a screen 1120 by a projection lens 1114.

Since the projection display device of the present exemplary embodiment has the liquid crystal device according to the above-mentioned exemplary embodiment, the projection display device can display an image with a high contrast ratio.

Further, the technical field of the exemplary embodiments of present invention is not limited to the above-mentioned exemplary embodiments, and various modifications and changes can be made without departing from the spirit or scope of exemplary embodiments of the present invention. For example, it is possible to appropriately change the layer structure of each member, structure materials, the shapes of patterns, and the like described in the above-mentioned exemplary embodiments in detail.

1. A liquid crystal device having substantially rectangular-shaped pixel regions, the device comprising:
a pair of substrates;
a liquid crystal layer interposed between the pair of substrates, the liquid crystal layer having a clear viewing direction that obliquely intersects a side of a pixel region; and
a metal light-shielding pattern provided on at least one of the pair of substrates, the metal light-shielding pattern having a grid shape with sections extending substantially in a direction parallel to an axis of polarized incident light and in a direction perpendicular thereto, the sections of the metal light-shielding pattern intersecting at corners of the rectangular-shaped pixel regions, the metal light-shielding pattern having an edge portion located at least at one of the corners of each rectangular-shaped pixel regions, each edge portion obliquely intersecting the axis of the polarized incident light, the metal light-shielding pattern having an another edge portion extending both substantially in a direction parallel to and perpendicular to the axis of the polarized incident light at a corner of the pixel region located at a side opposite to the clear viewing direction of the liquid crystal layer.

2. The liquid crystal device according to claim 1,
the pair of substrates being an element substrate having pixel switching elements thereon and a counter substrate, and the metal light-shielding pattern being provided closer to a light-incident side than the pixel switching element in the element substrate.

3. The liquid crystal device according to claim 2,
a light-shielding pattern being provided on the counter substrate and the light-shielding pattern covering the vicinity of a corner of an opening portion in the metal light-shielding pattern, the corner being located at the side opposite to the clear viewing direction.

4. The liquid crystal device according to claim 1,
the metal light-shielding pattern being composed of a pattern extending substantially in the direction parallel to the polarizing axis of the incident light and a pattern extending substantially in the direction perpendicular thereto, and these patterns being formed on different layers.

5. A projection display device, comprising:
a light source;
a light modulating device to modulate light from the light source, the light modulating device including the liquid crystal device according to claim 1 and
a projecting device to project the light modulated by the modulating device.
